(19) United States
(12) Patent Application Publication
(10) Pub. No.: US 2013/0334081 A1
(43) Pub. Date: Dec. 19, 2013

(54) FOLDABLE TRAVEL BAGS AND METHODS TO MANUFACTURE FOLDABLE TRAVEL BAGS

(71) Applicants: John H. Loudenslager, Phoenix, AZ (US); Brian J. McGuire, Phoenix, AZ (US)

(72) Inventors: John H. Loudenslager, Phoenix, AZ (US); Brian J. McGuire, Phoenix, AZ (US)

(21) Appl. No.: 13/587,104

(22) Filed: Aug. 16, 2012

Related U.S. Application Data
(60) Provisional application No. 61/661,497, filed on Jun. 19, 2012.

(51) Int. Cl. A63B 55/00; B23P 11/00; B65D 85/20

(52) U.S. Cl. 206/315.8; 206/315.1; 29/454

(57) ABSTRACT

Embodiments of a foldable travel bag and methods to manufacture such a bag are generally described herein. The foldable travel bag generally includes a plurality of reinforcement elements, at least two of the plurality of reinforcement elements coupled to a hinge joint portion, and a flexible cover portion extending between the plurality of reinforcement elements. The flexible cover portion defines a sealable housing to store an elongate object, and is configured to contract in response to at least two of the plurality of reinforcement elements being in a folded position. The flexible cover portion is also configured to expand in response to the at least two of the plurality of reinforcement elements being in an unfolded position.

### CROSS-REFERENCE TO RELATED APPLICATIONS

This application claims the benefit of U.S. Provisional Application No. 61/661,497, filed Jun. 19, 2012, the content of which is incorporated herein by reference in its entirety.

### FIELD

The present disclosure relates to a foldable travel bag for carrying elongate object(s), and in particular for golf bags.

### BACKGROUND

Many golf bags may be in the form of a tubular fabric or leather container having a generally cylindrical configuration with a closed bottom end and an open top end through which golf clubs are inserted into and removed from the golf bags. During traveling, particularly on airlines, a travel cover as part of a golf bag may be used for transporting golf clubs. In particular, the travel cover may include a soft cover that attaches at the top of the golf bag, covering the golf clubs, but not the golf bag itself. The soft cover may be useful to contain the clubs in the golf bag and to restrict the rattling of the clubs. Moreover, the soft cover is typically lightweight and collapsible for storage. However, transit systems tend to be taxing on baggage, particularly those made from a soft material. For example, the soft cover may become worn and potentially torn by getting stuck or snagged on equipment such as doors, escalators, conveyors, stairs, carts, handrails, and armrests.

In another construction, the travel cover may be made from a hard plastic. A hard travel cover may provide relatively more protection from impact, wear, and tear, and may also be more stable. The hard travel cover may be dimensioned for storing elongate object(s) such as a golf bag carrying one or more golf clubs. However, hard travel covers can be bulky as they may need to provide a rigid structure that is large enough to fit a variety of sizes of golf bags carrying golf clubs. The large size of the hard travel cover compared to a soft travel cover may require additional space for storing or transporting and therefore the hard travel cover can be difficult or cumbersome to store or transport. Thus, there has developed a need for a travel bag that protects a golf bag carrying golf clubs from impact and enables storing or transporting the travel bag in a compact footprint.

### BRIEF DESCRIPTION OF THE DRAWINGS

FIG. 1 is a front perspective view of a foldable travel bag according to one embodiment of the apparatus, methods, and articles of manufacture described herein;

FIG. 2 is a rear perspective view of the foldable travel bag of FIG. 1;

FIG. 3 is a perspective view of the foldable travel bag of FIG. 1, illustrating the foldable travel bag as partially unfolded;

FIG. 4 is a perspective view of the foldable travel bag of FIG. 1, illustrating the foldable travel bag as fully folded;

FIG. 5 is an enlarged partial perspective view of the foldable travel bag of FIG. 1, illustrating a joint handle;

FIG. 6 is an enlarged partial perspective view of the foldable travel bag of FIG. 1, illustrating a reinforcement fastener;

FIG. 7 is a side view of a foldable travel bag according to another embodiment, illustrating the foldable travel bag as fully folded;

FIG. 8 is a front side view of the foldable travel bag of FIG. 7, illustrating the foldable travel bag as fully unfolded;

FIG. 9 is a side view similar to FIG. 8, but from a direction rotated 90° about a longitudinal axis of the foldable travel bag;

FIG. 10 is a rear side view of the foldable travel bag of FIG. 7, illustrating reinforcement elements; and

FIG. 11 is a flow chart illustrating a method for manufacturing the foldable travel bag.

Corresponding reference characters indicate corresponding elements among the various views of the drawings. The headings used in the figures should not be interpreted to limit the scope of the claims.

### DESCRIPTION

As described herein, a foldable travel bag is configured and arranged to be folded for stowing, and unfolded for carrying elongate object(s). During traveling, particularly on airlines, the travel bag can be advantageously unfolded for carrying elongate object(s) such as a golf bag carrying one or more golf clubs or the golf clubs themselves. In the unfolded position, the travel bag suitably provides protection from impact, wear, and tear. Upon arrival at the destination, e.g., a hotel room or home, an individual can conveniently fold the travel bag and thereby store the travel bag in a compact footprint. The travel bag generally includes a plurality of reinforcement elements. At least two of the plurality of reinforcement elements are coupled to each other at a hinge joint portion, and a flexible cover portion extends between the plurality of reinforcement elements. The flexible cover portion defines a sealable housing for storing the elongate object(s). The flexible cover portion is configured to contract in response to the plurality of reinforcement elements being in a folded position, and to expand in response to the plurality of reinforcement elements being in an unfolded position. The travel bag may be used, for example, for carrying a golf bag with golf clubs, golf clubs themselves, ski equipment, and hockey sticks.

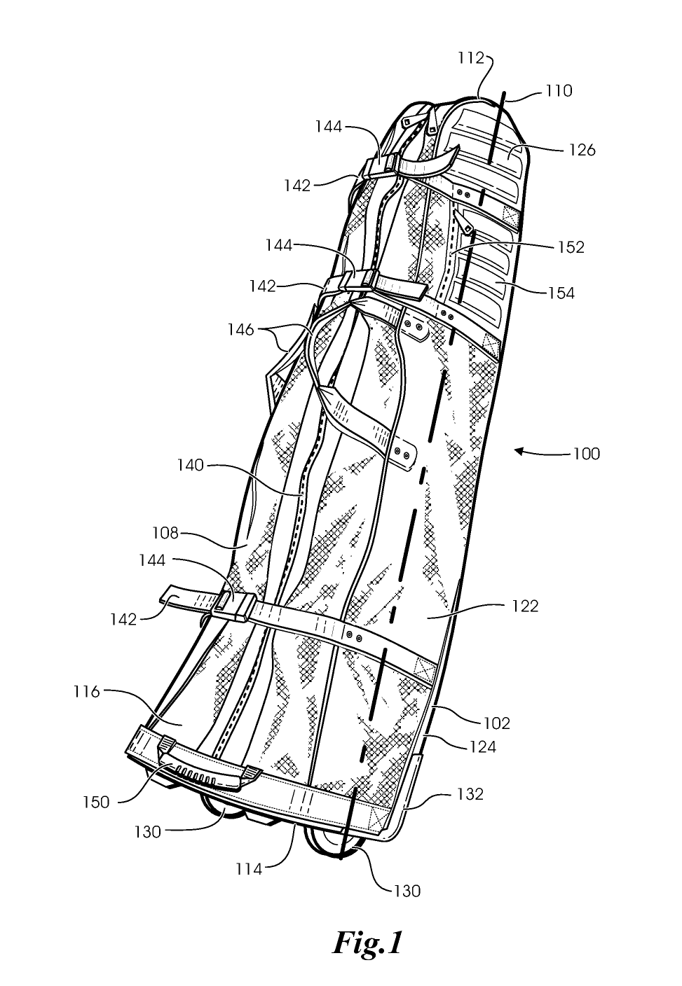

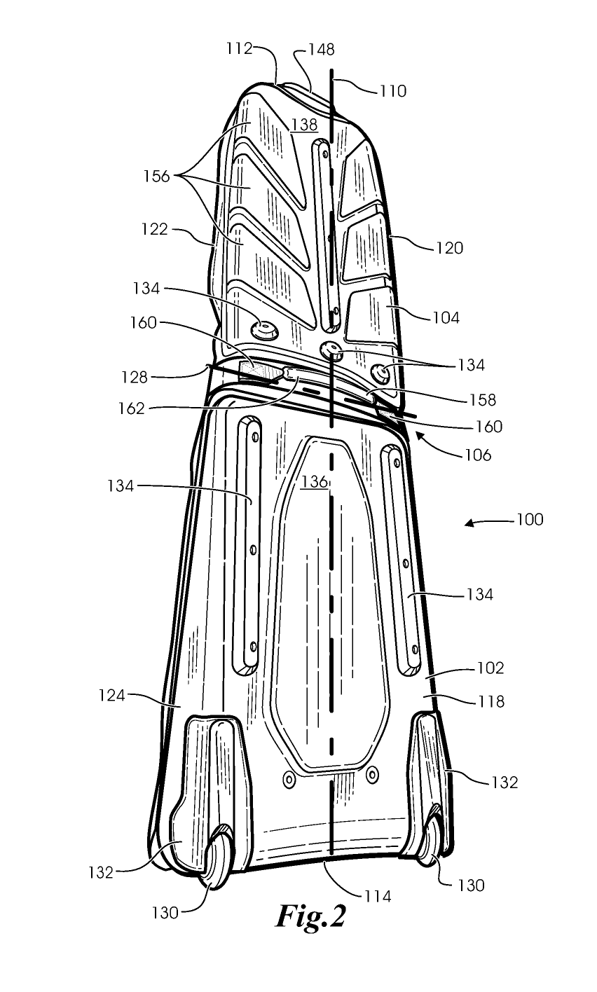

Referring to FIGS. 1 and 2, for example, a foldable travel bag 100 is illustrated in the unfolded position. The foldable travel bag 100 includes two reinforcement elements 102, 104 coupled to each other at a hinge joint portion 106. Although FIGS. 1 and 2 illustrate the foldable travel bag 100 as including two reinforcement elements 102, 104, in other embodiments the foldable travel bag 100 may include more than two reinforcement elements, which are suitably articulated, e.g., using linkages or hinges. For example, the foldable travel bag 100 may include two or more, three or more, four or more, five or more, six or more, seven or more, eight or more, nine or more, or ten or more reinforcement elements. The foldable travel bag 100 is associated with a height when the bag 100 is in the unfolded position. In some embodiments, the height of the foldable travel bag 100 may be greater than the height of the elongate object(s) stored or contained therein. In other embodiments, however, the height of the foldable travel bag 100 may be substantially similar to, or even slightly less than, the height of the elongate object(s) stored or contained therein. In some embodiments, the height of the foldable travel bag 100 may be so dimensioned as to fit in a trunk or back seat of a vehicle.

A flexible cover portion 108 extends between the reinforcement elements 102, 104. In some embodiments, the flexible cover portion 108 is coupled to both of the reinforcement element 102, 104 via sewing, riveting, a snap, a hook-and-loop fastener, or other suitable fasteners. The flexible cover portion 108 defines a sealable housing for storing an elongate object (not shown). Each reinforcement element 102, 104 may be molded or formed of a suitably rigid or stiff material selected from the group consisting of synthetic resin (e.g., polyethylene, polypropylene, polycarbonate, polystyrene, or polyvinyl chloride), thermoplastic rubber, fiberglass, metal, or entrapped air bubbles, or can be made in other manners from other materials. The flexible cover portion 108 may be formed of a suitably flexible material such as fabric material (e.g., polyester, nylon, canvas, or denim), leather, synthetic rubber, neoprene, polyethylene, polyurethane, acrylonitrile butadiene styrene, plastic, or a combination thereof, or can be made in other manners from other materials. The apparatus, methods, and articles of manufacture described herein are not limited in this regard.

As will be explained further below, the reinforcement elements 102, 104 are configured to fold and unfold so that the flexible cover portion 108 may contract and expand. In the unfolded position, the foldable travel bag 100 is a generally rectangular box or six-sided object that measures longer in a direction along a longitudinal axis 110 generally extending between a top portion 112 and a bottom portion or underside 114, and shorter in a direction that is perpendicular to the longitudinal direction. The illustrated top and bottom portions 112, 114 are substantially parallel to each other, and are connected by four side portions: a front side 116, a rear side 118 (see FIG. 2) that is made up of the reinforcement elements 102, 104, and left and right sides 120, 122 (only the right side 122 is shown in FIG. 1; the left side 120 is positioned substantially symmetrical relative to the longitudinal axis 110 in FIG. 1). As used herein, the terms “top,” “bottom,” “front,” “rear,” “side,” and other directional terms are not intended to require any particular orientation, but are instead used for purposes of description only.

In some embodiments, the plurality of reinforcement elements 102, 104 are associated with a first impact strength, the flexible cover portion 108 is associated with a second impact strength, and the first impact strength is greater than the second impact strength. That is, the flexible cover portion 108 may have an impact strength that is less than the impact strength of the reinforcement elements 102, 104. As such, the reinforcement elements 102, 104 can resist a higher impact compared to the flexible cover portion 108.

In the illustrated embodiment, at least one of the plurality of reinforcement elements 102, 104 comprises a surface 124 that tapers in a direction along the longitudinal axis 110 associated with the foldable travel bag 100. The surface 124 can be wedge-shaped when viewed in a direction perpendicular to the longitudinal axis 110. For example, the surface 124 can be an equilateral, isosceles, or scalene triangle when viewed in a direction perpendicular to the longitudinal axis 110. In other embodiments, at least one of the reinforcement elements 102, 104 can include a surface that tapers in a direction along the longitudinal axis 110. Other configurations are possible depending on the usage requirements or preferences for the particular foldable travel bag 100, including configurations where all surfaces of both of the reinforcement elements 102, 104 are substantially uniform in a direction along the longitudinal axis 110.

In the illustrated embodiment, the reinforcement elements 102, 104 are associated with a reinforcement surface area, the foldable travel bag 100 is associated with a bag surface area when the plurality of reinforcement elements 102, 104 are in the unfolded position, and the reinforcement surface area is at least about one third of the bag surface area. In some embodiments, the reinforcement surface is at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, or at least 60% of the bag surface area. In further embodiments, the reinforcement surface is no more than 60%, no more than 59%, no more than 58%, no more than 57%, no more than 56%, no more than 55%, no more than 54%, no more than 53%, no more than 52%, no more than 51%, no more than 50%, no more than 49%, no more than 48%, no more than 47%, no more than 46%, no more than 45%, no more than 44%, no more than 43%, no more than 42%, no more than 41%, no more than 40%, no more than 39%, no more than 38%, no more than 37%, no more than 36%, no more than 35%, no more than 34%, no more than 33%, no more than 32%, no more than 31%, or no more than 30% of the bag surface area. As such, the reinforcement surface can be 30% to 60%, 30% to 50%, or 30% to 40% of the bag surface area. Depending on the usage requirements or preferences for the particular foldable travel bag 100, a reinforcement surface that covers less than about 30% of the bag surface area may not provide the requisite structural rigidity, stiffness, hardness, strength, impact strength, or a combination thereof.

In some embodiments, the reinforcement elements 102, 104 extend over a plurality of quadrants of the flexible cover portion 108 when the reinforcement elements 102, 104 are in the unfolded position. A quadrant as used herein may include two adjacent corners of the flexible cover portion 108, one or more portions of the top, side, or bottom of the flexible cover portion 108, or a combination thereof.

In the illustrated embodiment, the reinforcement elements 102, 104 are flexibly coupled to each other at the hinge joint portion 106. That is, the hinge joint portion 106 includes a fabric, to which the reinforcement elements 102, 104 are sewn. In some embodiments, the hinge joint portion 106 may include a joint reinforcement (not shown) substantially surrounded by the fabric. In other embodiments, the reinforcement elements 102, 104 may be integrally formed as one piece, and the hinge joint portion 106 may be a crease, i.e., thinner in cross section relative to adjacent portions of the reinforcement elements 102, 104. The hinge joint portion 106 is positioned preferably about half way between the top and bottom portions 112, 114 of the foldable travel bag 100.

In the illustrated embodiment, a reinforcement sheet or padding 126 is coupled to the flexible cover portion 108 on each of the left and right sides 120, 122. The reinforcement sheets 126 are substantially perpendicular to a joint axis 128 associated with the hinge joint portion 106 when the plurality of reinforcement elements 102, 104 are in the unfolded position. The reinforcement sheets 126 may be molded or formed of a suitably rigid or stiff material such as synthetic resin (e.g., polyethylene or polypropylene), and can help protect the elongate object stored in the foldable travel bag 100, e.g., a golf club, from impact. In particular, the reinforcement sheets 126 may be positioned to protect club heads or a golf bag carrying the golf clubs from impact. In some embodiments, the reinforcement sheets 126 are associated with an impact strength that is greater than the impact strength of the flexible cover portion 108 and less than the impact strength of the plurality of reinforcement elements 102, 104.

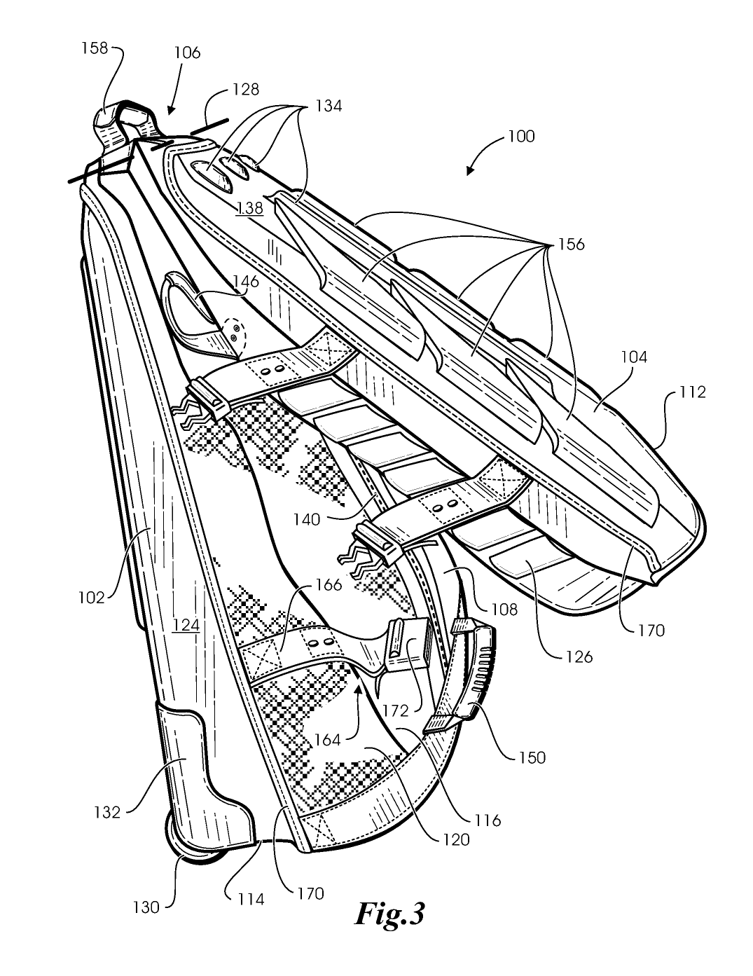

The flexible cover portion 108, to which the reinforcement sheets 126 are coupled, can be suitably collapsed when the plurality of reinforcement elements 102, 104 are in the folded position or partially unfolded (see FIG. 3). Accordingly, the reinforcement sheets 126 are at an acute angle to the joint axis 128 associated with the hinge joint portion 106 when the plurality of reinforcement elements 102, 104 are in the folded position. In some embodiments, at least one of the reinforcement sheet 126 is at an angle of at least 0°, at least 10°, at least 20°, at least 30°, at least 40°, at least 50°, at least 60°, at least 70°, or at least 80° relative to the joint axis 128. In further embodiments, at least one of the reinforcement sheet 126 is at an angle of no more than 90°, no more than 80°, no more than 70°, no more than 60°, no more than 50°, no more than 40°, no more than 30°, no more than 20°, or no more than 10° relative to the joint axis 128. As such, at least one of the reinforcement sheet 126 can be at an angle of 0° to 90°, 10° to 80°, or 20° to 70° relative to the joint axis 128.

In the illustrated embodiment, two wheels 130 are positioned at or proximate to the bottom portion 114 of the foldable travel bag 100, e.g., for transporting the foldable travel bag 100 on the ground (not shown). Although FIGS. 1 and 2 illustrate the foldable travel bag 100 with two wheels 130, it is to be appreciated that other embodiments may utilize other numbers of wheels 130. In further embodiments, the foldable travel bag 100 may include a locking mechanism (not shown) to selectively hold the wheels 130 in place. In still other embodiments, the foldable travel bag 100 may include fewer than both of the wheels 130. In some embodiments, a suitably ruggedized frame 132 may be interposed between the wheels 130 and the reinforcement element 102 of the foldable travel bag 100. The frame 132 may be coupled to the reinforcement element 102 via riveting, adhesive, or other suitable fasteners. In further embodiments, the bottom portion 114 of the foldable travel bag 100 may include a bottom reinforcement (not shown) formed of a suitably rigid or stiff material such as a honeycomb board.

In the illustrated embodiment, each reinforcement element 102, 104 includes at least one raised surface 134 to engage the ground, e.g., providing friction when the respective reinforcement element 102, 104 contacts the ground. As such, the raised surface 134 can prevent skidding when a respective outer surface 136, 138 of the reinforcement elements 102, 104 contacts the ground. Although in the illustrated embodiment the first reinforcement element 102 includes two raised surfaces 134 and the second reinforcement element 104 includes one raised surface 134, in other embodiments, each of the reinforcement elements 102, 104 can suitably include other numbers of raised surfaces 134. In still other embodiments, the reinforcement elements 102, 104 may include fewer than all the illustrated raised surfaces 134. In the illustrated embodiment, each raised surface 134 has the shape of an elongated strip or circle when viewed from above. In other embodiments, however, each raised surface 134 may assume any geometric form when viewed from above, including, but not limited to, a polygon, an oval, an ellipse, a lens, a squircle, a symbol, or a combination thereof.

Referring to FIG. 1, a zipper 140 is associated with the flexible cover portion 108 so as to separate the flexible cover portion 108 into two pieces, i.e., one piece including the left side 120 and the other piece including the right side 122. In some embodiments, other structures performing the same function as the zipper 140 disclosed herein can be used instead, including, but not limited to, one or more buttons, snaps, hook-and-loop fasteners, or other suitable fasteners. Although FIG. 1 illustrates the zipper 140 as extending substantially parallel to the longitudinal axis 110, in other embodiments, the zipper 140 may extend in other suitable configurations, e.g., in a U-shaped configuration near the top portion 112 of the flexible cover portion 108 so as to separate the front side 116 from the rear side 118. The U-shaped zipper 140 may suitably make it easier to load and access the elongate object(s).

In the illustrated embodiment, the foldable travel bag 100 includes housing fasteners 142 extending across the zipper 140 of the sealable housing, i.e., around a circumference of the foldable travel bag 100. Each housing fastener 142 includes a guide member 144 configured to adjust a length of the respective housing fastener 142. As such, the housing fasteners 142 can compress the flexible cover portion 108 for tightly enclosing the elongate object therein. Although FIG. 1 illustrates three housing fasteners 142 extending across the sealable housing of the flexible cover portion 108, it is to be appreciated that other embodiments may utilize other numbers of housing fasteners 142. For example, the foldable travel bag 100 may include one or more, two or more, three or more, four or more, five or more, six or more, seven or more, eight or more, nine or more, or ten or more housing fasteners 142.

In the illustrated embodiment, a housing handle 146 is coupled to each of the left and right side 120, 122 of the flexible cover portion 108 away from the zipper 140 for lifting or lowering the foldable travel bag 100. The housing handles 146 may be coupled to the flexible cover portion 108 via sewing, riveting, adhesive, or other suitable fasteners. In operation, an individual (not shown) may grab one or both of the housing handles 146 and lift or lower the foldable travel bag 100.

Referring to FIG. 2, the illustrated foldable travel bag 100 also includes a top handle 148 coupled to the reinforcement element 104 at the top portion 112 of the foldable travel bag 100. In some embodiments, the top handle 148 is directly coupled to the reinforcement element 104 by riveting. That is, the top handle 148 is coupled to the reinforcement element 104 without necessarily being coupled to the flexible cover portion 108. As such, the top handle 148 can provide a stable control and comfortable maneuverability when rolling or moving the foldable travel bag 100. In other embodiments, the top handle 148 may be directly or indirectly coupled to the reinforcement element 104 via sewing, riveting, adhesive, or other suitable fasteners. In some embodiments, the top handle 148 may be coupled to at least one of the plurality of reinforcement elements at or proximate to the top portion 112 of the foldable travel bag 100. In operation, an individual (not shown) may maneuver, transport, or move the foldable travel bag 100 over the ground by gripping the top handle 148, pivoting the foldable travel bag 100 about the wheels 130 to suitably raise or lower the top portion 112, and pushing or pulling the foldable travel bag 100, rolling the foldable travel bag 100 on the wheels 130.

As illustrated in FIG. 1, the illustrated foldable travel bag 100 also includes a bottom handle 150 at the bottom portion 114 of the foldable travel bag 100. The bottom handle 150 may be coupled to the bottom portion 114 of the foldable travel bag 100 via sewing, riveting, adhesive, or other suitable fasteners. In some embodiments, the bottom handle 150 may be positioned proximate to the bottom portion 114 of the foldable travel bag 100. In operation, an individual may grab the top handle 148 with one hand and grab the bottom handle 150 with the other hand, and then lift or lower the foldable travel bag 100 using both hands.

In the illustrated embodiment, the foldable travel bag 100 includes at least one storage compartment 152 associated with the flexible cover portion 108. The illustrated storage compartment 152 includes a wall 154 coupled to the flexible cover portion 108, e.g., via sewing, adhesive, or other suitable fasteners. In some embodiments, the wall 154 may be formed from a substantially transparent or translucent material so that the inside is visible. As such, the storage compartment 152 may be used to store for example, a decorative or informational item, e.g., a business card. In some embodiments, at least a portion of the flexible cover portion 108 may be used to display an insignia (not shown) including, but not limited to, a name brand, a company logo, personalized artwork, a photograph, a team logo, or other verbal and pictorial content. The insignia may be embroidered or coupled to the flexible cover portion 108 in other manners.

Referring to FIG. 2, the reinforcement elements 102, 104 each comprise a pliable material on the respective outer surface 136, 138. In the illustrated embodiment, the pliable material forms a plurality of reinforcement ribs 156 on the respective outer surface 136, 138. The reinforcement ribs 156 are slightly raised relative to adjacent portions of the outer surface 136, 138. The pliable material of the reinforcement ribs 156 can help reduce impact to the elongate object contained in the foldable travel bag 100, and also suitably resist wear and tear, thereby increasing the durability of the foldable travel bag 100. In some embodiments, the pliable material may be substantially free of webbing material.

FIG. 3 illustrates the foldable travel bag 100 as partially unfolded. An individual can fold the foldable travel bag 100 from an unfolded position to a folded position, for example by grasping the second reinforcement element 104 proximate to the top portion 112 of the foldable travel bag 100 and rotating the second reinforcement element 104 downwardly about the joint axis 128 toward the first reinforcement element 102. The joint axis 132 is associated with the hinge joint portion 106 and perpendicular to the longitudinal axis 110. In the illustrated embodiment, a reinforcement fastener 164 with two straps 166 extends across the reinforcement elements 102, 104. Each illustrated strap 166 extends from an interface 170, where the first reinforcement element 102 and the flexible cover portion 108 engage each other, toward a corresponding strap 166. As explained further below, the straps 166 are coupled to each other via a clip 172, thus coupling the first and second reinforcement elements 102, 104 together.

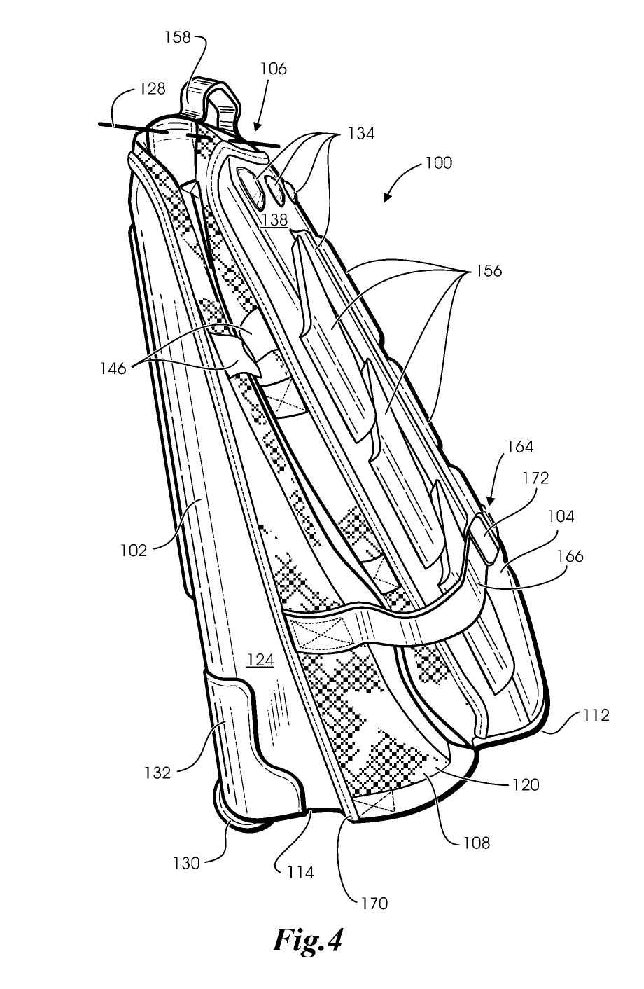

FIG. 4 illustrates the foldable travel bag 100 as fully folded. The foldable travel bag 100 is fully folded when the top portion 122 of the foldable travel bag 100 is abutting against the bottom portion 114 of the foldable travel bag 100. In the folded position, the foldable travel bag 100 allows an individual to store the foldable travel bag 100 tidily and in a compact footprint. To unfold the foldable travel bag 100, the second reinforcement element 104 is rotated upwardly about the joint axis 128 so that the second reinforcement element 104 extends upwardly and away from the first reinforcement element 102. In some embodiments, the reinforcement elements 102, 104 provide an abutment stop to each other when the foldable travel bag 100 is fully unfolded.

In some embodiments, the foldable travel bag 100 may include a locking unit configured to releasably lock the plurality of reinforcement elements 102, 104 in the fully unfolded position. The locking unit may include a detent and a corresponding catch mechanism, and a release member connected to the detent. The release member may be spring-loaded or biased by any other suitable mechanisms. The detent is selectively movable between a locked position where the detent contacts the corresponding catch mechanism, and an unlocked position where the detent is released out of the locking position. When the second reinforcement element 104 is rotated upwardly from the folded position toward the unfolded position, the detent contacts the catch mechanism and locks the second reinforcement element 104 so that the second reinforcement element 102 fixedly extends upwardly and away from the first reinforcement element 102. When the release member is depressed against the bias, the detent is released out of the locking position, thereby enabling the second reinforcement element 104 to rotate or fold downwardly toward the folded position.

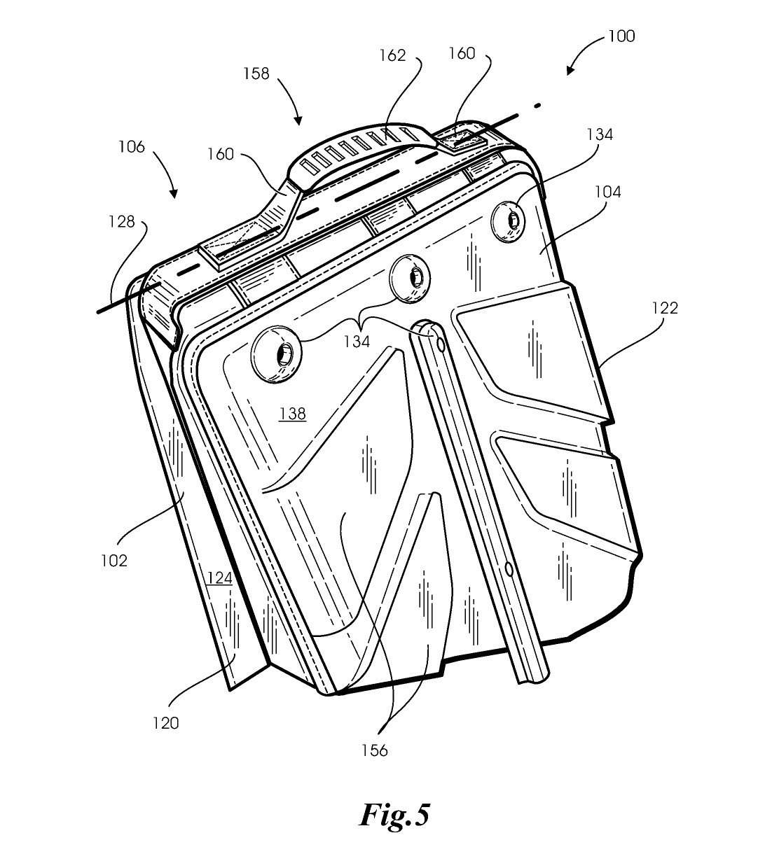

Referring also to FIG. 5, a joint handle 158 is coupled to the hinge joint portion 106. The joint handle 158 includes a webbing 160 coupled to the hinge joint portion 106, and a grip 162 that is secured to the webbing 160. The grip 162 may be formed of a suitable material such as vinyl. Although in the illustrated embodiment the webbing 160 and the grip 162 are separate, it is to be appreciated that in other embodiments the webbing 160 and the grip 162 may be integrally formed as one piece. In the illustrated embodiment, the webbing 160 of the joint handle 158 is coupled to the hinge joint portion 106 using box stitches. In other embodiments, however, the joint handle 158 can be coupled to the hinge joint portion 106 via riveting, adhesive, or other suitable fasteners. In still other embodiments, the joint handle 158 and the hinge joint portion 106 can be co-molded.

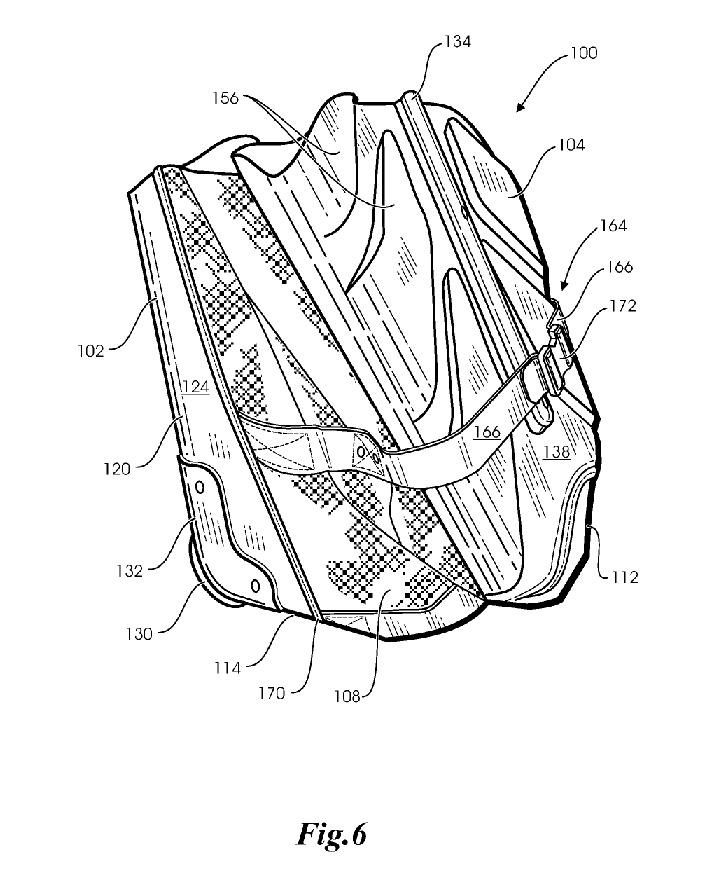

FIG. 6 illustrates the foldable travel bag 100 as fully folded. In the illustrated embodiment, each strap 166 extends from a respective interface 170 toward a position over the second reinforcement element 104. The straps 166 are coupled to each other via a clip 172 at a position over the second reinforcement element 104. The reinforcement fastener 164 thus couples the first and second reinforcement elements 102, 104 together when the straps 166 are coupled to each other. In some embodiments, one or both of the straps 166 may extend from any position associated with the reinforcement elements 102, 104, or the flexible cover portion 108 to suitably couple the first and second reinforcements 102, 104 together.

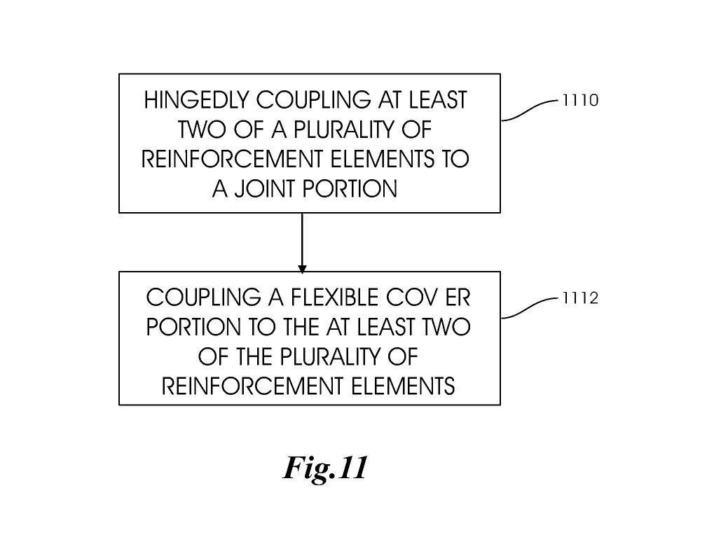

According to one aspect, a method of manufacturing the foldable travel bag 100 generally includes hingedly coupling the reinforcement elements 102, 104 to the hinge joint portion 106, and coupling the flexible cover portion 108 to the plurality of reinforcement elements 102, 104. In the example of FIG. 11, a process 1100 may begin with hingedly coupling at least two of a plurality of reinforcement elements 102, 104 to the hinge joint portion 106 (block 1110). At block 1112, the flexible cover portion 108 is coupled to the plurality of reinforcement elements 102, 104. The flexible cover portion 108 defines a sealable housing to store an elongate object, and as described above, is configured to contract in response to the plurality of reinforcement elements 102, 104 being in the folded position. The flexible cover portion 108 is also configured to expand in response to the plurality of reinforcement elements 102, 104 being in the unfolded position. In some embodiments, the method further includes coupling the joint handle 158 to the hinge joint portion 106. In further embodiments, the method further includes coupling the pliable material on the respective outer surface 136, 138 of at least one of the plurality of reinforcement elements 102, 104. While a particular order of actions is illustrated in FIG. 11, these actions may be performed in other temporal sequences. For example, two or more actions depicted in FIG. 11 may be performed sequentially, concurrently, or simultaneously. Alternatively, two or more actions depicted may be performed in reversed order. Further, one or more actions depicted in FIG. 11 may not be performed at all.

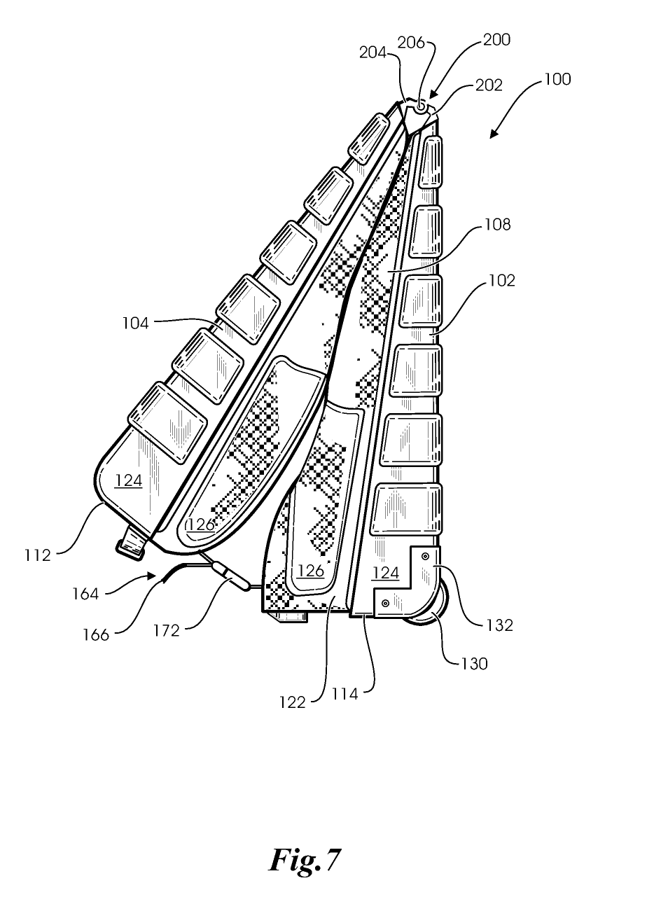

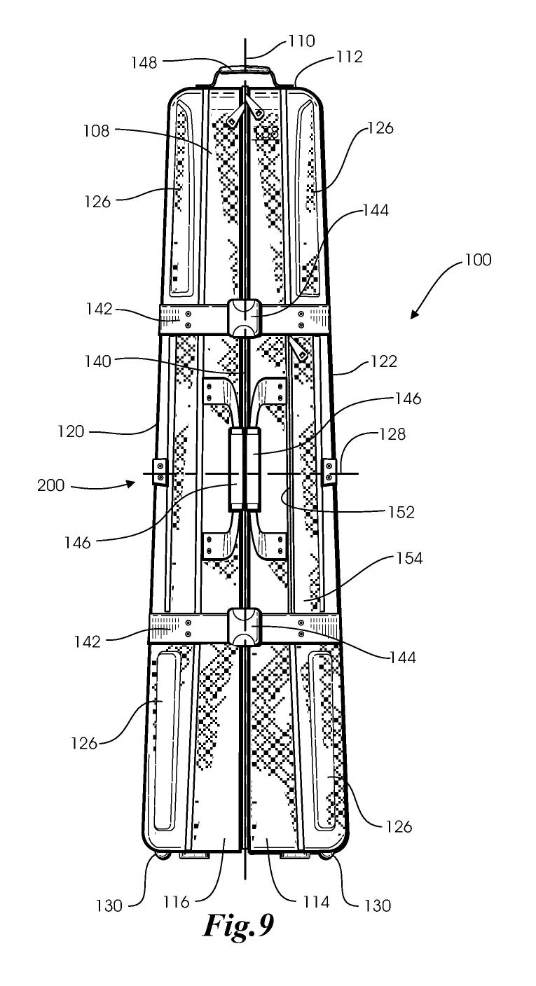

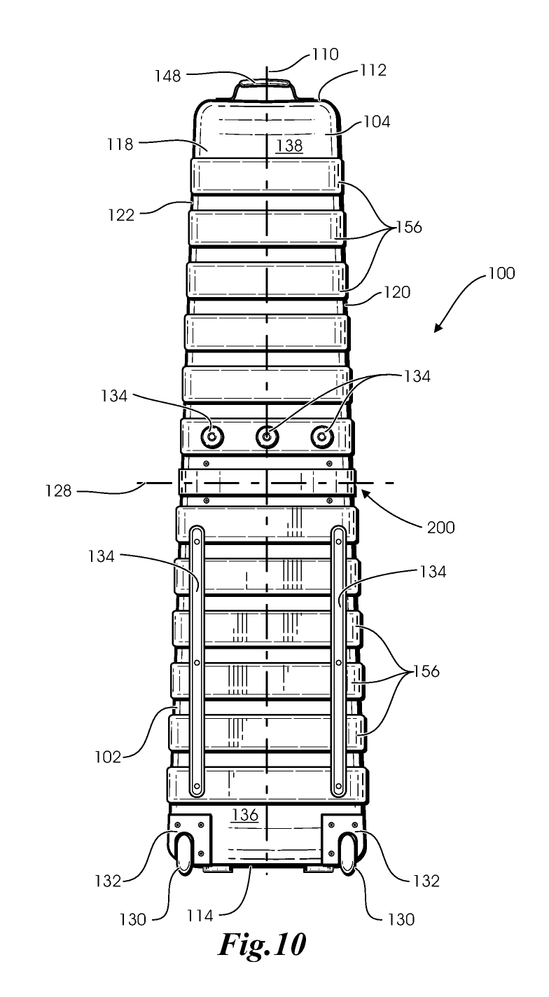

FIGS. 7-10 illustrate the foldable travel bag 100 according to another embodiment. This embodiment employs much of the same structure and has many of the same properties as the embodiment of the foldable travel bag 100 described above in connection with FIGS. 1-6. Accordingly, the following description focuses primarily upon the structure and features that are different than the embodiment described above in connection with FIGS. 1-6. Reference should be made to the description above in connection with FIGS. 1-6 for additional information regarding the structure and features, and possible alternatives to the structure and features of the foldable travel bag 100 illustrated in FIGS. 7-10 and described below. Structure and features of the embodiment shown in FIGS. 7-10 that correspond to structure and features of the embodiment of FIGS. 1-6 are designated hereinafter with like reference numbers.

In this embodiment, the hinge joint portion 200 includes a female member 202 coupled to the first reinforcement element 102 of the plurality of reinforcement elements 102, 104, and a male member 204 coupled to the second reinforcement element 104 of the plurality of reinforcement elements 102, 104 and positioned proximate to the female member 202. A rod 206 is insertable through the female and male members 202, 204 to couple the first and second reinforcement elements 102, 104 together.

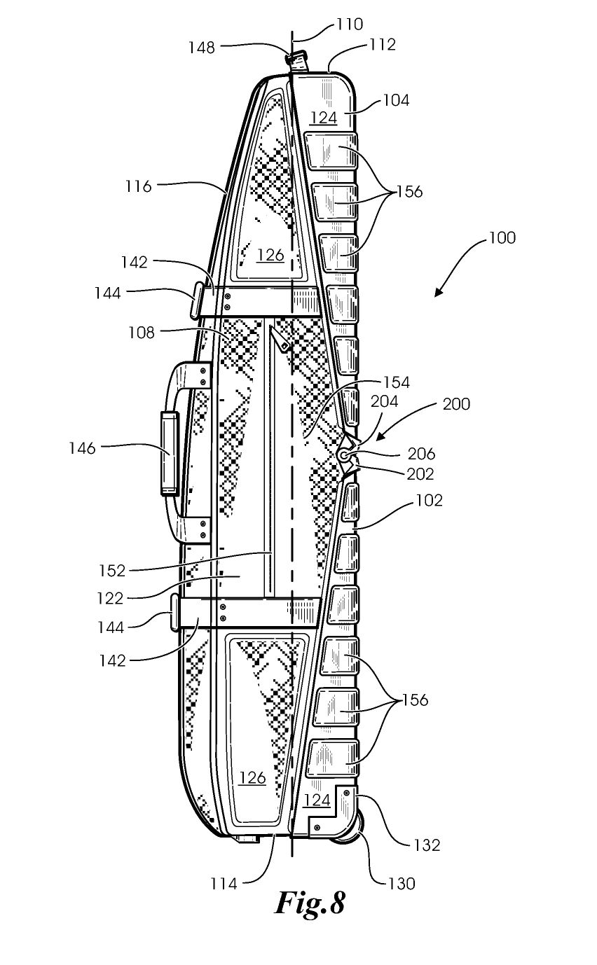

Although in the illustrated embodiment only a single female member 202 on the first reinforcement element 102 and only a single male member 204 on the second reinforcement element 104 are shown, in further embodiments, the first reinforcement element 102 may include one or more female members 202, one or more male members 204, or a combination thereof. Similarly, the second reinforcement element 104 may also include one or more male members 204, one or more female members 202, or a combination thereof. The hinge joint portion 200 thus suitably includes one or more female and male members 202, 204. Moreover, although FIGS. 7 and 8 illustrate the female and male members 202, 204 as integrally formed with the first and second reinforcement elements 102, 104, respectively, in other embodiments the female and male members 202, 204 may be separately formed and attached to a respective one of the first and second reinforcement elements 102, 104 via glue or fasteners.

In the illustrated embodiment, the first and second reinforcement elements 102, 104 are substantially symmetrical from a view along the joint axis 128. In other embodiments, however, the first and second reinforcement element 102, 104 are not substantially symmetrical from a view along the joint axis 128 (see, e.g., FIGS. 3 and 4).

In the illustrated embodiment, the reinforcement ribs 156 extend in a lateral direction substantially parallel to the joint axis 128. The laterally extending reinforcement ribs 156 can engage an edge of stairs or escalators, and therefore can be helpful in preventing the foldable travel bag 100 from sliding downwardly on stairs, escalators, or other support structures.

It should be understood from the foregoing that, while particular embodiments have been illustrated and described, various modifications can be made without departing from the spirit and scope of the disclosure as will be apparent to those skilled in the art. Such changes and modifications are within the scope and teachings of this disclosure as defined in the claims appended hereto.

What is claimed is:

1. A foldable travel bag comprising:
a plurality of reinforcement elements, at least two of the plurality of reinforcement elements coupled to a hinge joint portion; and
a flexible cover portion extending between the plurality of reinforcement elements, the flexible cover portion defining a sealable housing to store an elongate object,
wherein the flexible cover portion is configured to contract in response to the at least two of the plurality of reinforcement elements being in a folded position, and the flexible cover portion is configured to expand in response to the at least two of the plurality of reinforcement elements being in an unfolded position.

2. The foldable travel bag of claim 1, wherein the plurality of reinforcement elements comprises at least two reinforcement elements associated with a reinforcement surface area, the foldable travel bag is associated with a bag surface area when the at least two of the plurality of reinforcement elements are in the unfolded position, and the reinforcement surface area is at least about one third of the bag surface area.

3. The foldable travel bag of claim 1 further comprising a locking unit, the locking unit configured to releasably lock the at least two of the plurality of reinforcement elements in the unfolded position.

4. The foldable travel bag of claim 1, wherein the plurality of reinforcement elements comprises at least two reinforcement elements flexibly coupled to each other at the hinge joint portion.

5. The foldable travel bag of claim 1, wherein the hinge joint portion includes a female member coupled to a first reinforcement element of the plurality of reinforcement elements, a male member coupled to a second reinforcement element of the plurality of reinforcement elements and positioned proximate to the female member, and a rod insertable through the female and male members to couple the first and second reinforcement elements together.

6. The foldable travel bag of claim 1 further comprising a handle coupled to the hinge joint portion.

7. The foldable travel bag of claim 1 further comprising at least one fastener extending across at least two of the plurality of reinforcement elements when the at least two of the plurality of reinforcement elements are in the folded position.

8. The foldable travel bag of claim 1, wherein the plurality of reinforcement elements are associated with a first impact strength, the flexible cover portion is associated with a second impact strength, and the first impact strength is greater than the second impact strength.

9. The foldable travel bag of claim 1, wherein at least one of the plurality of reinforcement elements comprises a surface that tapers in a direction along a longitudinal axis associated with the foldable travel bag.

10. The foldable travel bag of claim 1, wherein the plurality of reinforcement elements comprise at least one of synthetic resin, thermoplastic rubber, fiberglass, metal, or entrapped air bubbles.

11. The foldable travel bag of claim 1, wherein at least one of the plurality of reinforcement elements comprises a pliable material on an outer surface of the at least one of the plurality of reinforcement elements.

12. The foldable travel bag of claim 1 further comprising at least one reinforcement sheet coupled to the flexible cover portion, wherein the reinforcement sheet is substantially perpendicular to a joint axis associated with the hinge joint portion when the at least two of the plurality of reinforcement elements are in the unfolded position.

13. The foldable travel bag of claim 1 further comprising at least one reinforcement sheet coupled to the flexible cover portion, wherein the reinforcement sheet is at an acute angle to a joint axis associated with the hinge joint portion when the at least two of the plurality of reinforcement elements are in the folded position.

14. The foldable travel bag of claim 1, wherein the elongate object comprises at least one of a golf bag, a golf club, a ski pole, a snowboard, or a hockey stick.

15. A method of manufacturing a foldable travel bag comprising:
hingedly coupling at least two of a plurality of reinforcement elements to a joint portion; and
coupling a flexible cover portion to the at least two of the plurality of reinforcement elements, the flexible cover portion defining a sealable housing to store an elongate object,
wherein the flexible cover portion is configured to contract in response to the at least two of the plurality of reinforcement elements being in a folded position, and the flexible cover portion is configured to expand in response to the at least two of the plurality of reinforcement elements being in an unfolded position.

16. The method of claim 15 further comprising coupling a handle to the joint portion.

17. The method of claim 15 further comprising coupling a pliable material on an outer surface of at least one of the plurality of reinforcement elements.

18. A bag comprising:
a plurality of reinforcement elements associated with a reinforcement surface area; and
a flexible cover portion extending between the plurality of reinforcement elements, the flexible cover portion having a sealable housing to receive an elongate object,
wherein the reinforcement surface area is at least about one third of a bag surface area associated with the bag, and
wherein at least one of the plurality of reinforcement elements includes a surface that tapers in a direction along a longitudinal axis associated with the bag.

19. The bag of claim 18 further comprising a hinge joint portion coupling at least two of the plurality of reinforcement elements.

20. The bag of claim 18 further comprising a hinge joint portion coupling at least two of the plurality of reinforcement elements, the at least two of the plurality of reinforcement elements configured to be in a folded position and an unfolded position, and a locking unit configured to releasably lock the at least two of the plurality of reinforcement elements in the unfolded position.

21. The bag of claim 18 further comprising a hinge joint portion coupling at least two of the plurality of reinforcement elements, the at least two of the plurality of reinforcement elements configured to be in a folded position and an unfolded position, and the plurality of reinforcement elements comprising at least two reinforcement elements flexibly coupled to each other at the hinge joint portion.

22. The bag of claim 18 further comprising a hinge joint portion coupling at least two of the plurality of reinforcement elements, the at least two of the plurality of reinforcement elements configured to be in a folded position and an unfolded position, and the hinge joint portion including a female member coupled to a first reinforcement element of the at least two of the plurality of reinforcement elements, a male member coupled to a second reinforcement element of the at least two of the plurality of reinforcement elements and positioned proximate to the female member, and a rod insertable through the female and male members to couple the first and second reinforcement elements together.

23. The bag of claim 18 further comprising a hinge joint portion and a handle coupled thereto.

24. The bag of claim 18 further comprising a hinge joint portion coupling at least two of the plurality of reinforcement elements, the at least two of the plurality of reinforcement elements configured to be in a folded position and an unfolded position, and at least one fastener extending across the at least two of the plurality of reinforcement elements when the at least two of the plurality of reinforcement elements are in the folded position.

25. The bag of claim 18, wherein the plurality of reinforcement elements are associated with a first impact strength, the flexible cover portion is associated with a second impact strength, and the first impact strength is greater than the second impact strength.

26. The bag of claim 18, wherein at least one of the plurality of reinforcement elements comprises a surface that tapers in a direction along a longitudinal axis associated with the bag.

27. The bag of claim 18, wherein the plurality of reinforcement elements comprise at least one of synthetic resin, thermoplastic rubber, fiberglass, metal, or entrapped air bubbles.

28. The bag of claim 18, wherein at least one of the plurality of reinforcement elements comprises a pliable material on an outer surface of the at least one of the plurality of reinforcement elements.

29. The bag of claim 18 further comprising at least one reinforcement sheet coupled to the flexible cover portion.

30. The bag of claim 18, wherein the elongate object comprises at least one of a golf bag, a golf club, a ski pole, a snowboard, or a hockey stick.

31. A foldable travel bag comprising:
a plurality of reinforcement elements, at least two of the plurality of reinforcement elements coupled to a hinge joint portion; and
a flexible cover portion extending between the plurality of reinforcement elements, the flexible cover portion defining a sealable housing to store an elongate object,
wherein the plurality of reinforcement elements are configured to extend over a plurality of quadrants of the flexible cover portion when the at least two of the plurality of reinforcement elements are in an unfolded position.

32. The foldable travel bag of claim 31 further comprising a handle coupled to the hinge joint portion.

33. The foldable travel bag of claim 31, wherein at least one of the plurality of reinforcement elements comprises a pliable material on an outer surface of the at least one of the plurality of reinforcement elements.
